(19) United States
(12) Patent Application Publication
(10) Pub. No.: US 2006/0147092 A1
(43) Pub. Date: Jul. 6, 2006

(54) Intelligent digital graphics inspection system and method

(75) Inventors: Jian Zhang, Hangzhou (CN); Wenjiang Han, Hangzhou (CN); Huiming Tang, Hangzhou (CN); Wende Li, Hangzhou (CN)

Correspondence Address: SYNNESTVEDT & LECHNER, LLP, 2600 ARAMARK TOWER, 1101 MARKET STREET, PHILADELPHIA, PA, 191072950, US

(73) Assignees: Wenjiang Han, Hangzhou (CN); Jian Zhang, Hangzhou (CN)

(21) Appl. No.: 11/271,188

(22) Filed: Nov. 10, 2005

(30) Foreign Application Priority Data
Dec. 31, 2004 (CN) 2004 1 0082206.X

(51) Int. Cl. G06K 9/00

(52) U.S. Cl. 382/112

(57) ABSTRACT

According to the present invention, there is provided a printed graphics inspection system and the inspection method thereof to inspect printed graphics including holograms. In the present invention improving the printing quality and reducing manpower cost are achieved by using of a plurality of sensors located in different angles to exclude zones not normally detectable on the graphics to be inspected, digitalizing the images inspected by such sensors, sending the digitalized images to a micro-processor, and using such micro-processor to analyze and process the images inspected and a set of corresponding templates to identify defects such as contamination, color deviation and the like.

### BACKGROUND OF THE INVENTION

The present invention relates to an intelligent digital graphics inspection system and inspection method thereof, particularly, to a system and method for inspecting printing quality.

With the progress of printing technologies, the products printed, especially that for packing purpose, are increasingly delicate. In addition to usage of color printing, dynamic holographic technology is applied. On the other hand, quality requirement for printed products is becoming higher and higher, particularly that for packing purpose, any visible defect is not allowed. This means that a strict quality inspection is needed in the course of printing. Furthermore, printing efficiency is getting more and more important. It is needed to monitor change of printing quality in printing process to allow on-line adjustment for improving the printing quality.

At present, manual visual inspection is the main method to inspect quality of printed product. As daily printing output from each printing workshop is big and the printing defect rate is high, a great number of trained inspectors are required for inspection, that wastes a lot of manpower and resources and induce easily happened missing and error when the inspector is tired.

Automation of printed products inspection is a tendency, and doubtlessly digital image processing technology is a new direction of development in printed products inspection. Image comparison method is a common printed products inspection method being used now, which is implemented through an image for a sample of printed product being inspected to compare with a template of such printed product by registration, differentiation or other image processing methods to find out the difference between the printed product and the template.

Since the development of holographic printing provides delicate printing and 3-D dynamic visional printing effect, it is not only used for anti-counterfeiting printing, but also increasingly used for package printing, for example, smoke mark printing However, for hologram it is not possible to take image directly as different color and image will appear while viewing from different direction or under differing light source because there is a diffraction from each pixel in its 3-D effect. Therefore, the simple image registration and differentiation method is not longer applicable and a new technology is required.

### SUMMARY OF THE INVENTION

The main objective of the present invention is to provide a printed graphics inspection system and inspection method thereof for inspecting all type of printed graphics, including dynamic holograms.

The solution to achieve the aforesaid objective in the present invention is providing an intelligent digital graphics inspection system comprising a conveying unit, an image signal picking-up unit, an image analysis and processing unit, and a communication controlling interface. In the conveying unit a photo-electronic inspection device is used to control the location of the graphics to be inspected in a correlation manner; in the image signal picking-up unit a set of image sensors is used to pick up image signals to get images of printed graphics to be inspected and image of templates for comparison purpose in different angles; and in the image analysis and processing unit these images are analyzed and processed.

Another aspect of the invention is a inspection method for intelligent digital graphics inspection system, comprising steps (1) template image processing, (2) graphics registration, (3) comparing the image to be inspected with the template image, (4) identifying defective type, and (5) output and controlling of processing result. In this system a plurality of sensors is installed to pick up template images for processing and an inspection zone is set for each sensor so that different zones are detected by different sensors and a combination of all such inspection zones forms the whole zone requiring inspection; the graphics registration process is used to register a plurality of images; the comparison is for a plurality of images with their respective corresponding template images; and the identification process includes an overall analysis on the type of defect on each image.

In the graphics registration process a geometric calibration method based on a minimum error registration search is applied, i.e., a plurality of sub-zones are first selected, registration is implemented with regional search, and a coordinate designated on the sub-zone is applied as a control point for geometric calibration of the whole image in order to increase the precision of graphics registration.

In the present invention a mode identification method is applied to identify the type of defects, including shape, color shift and other attributes of the image being inspected.

The present invention uses graphics analysis and processing technology to inspect printed graphics for different types of defects, such as contamination, color deviation, and the like, to provide an on-line control on printing quality in the course of printing. It eliminates the disadvantage of the prior art—not able to inspect holograms. The present invention also enhances automation in printed graphics inspection and effectively moderates the burden of inspecting printing quality and saves labor cost with a reasonable and highly expandable design.

### BRIEF DESCRIPTION OF THE DRAWINGS

FIG. 1 illustrates the structure of a preferred embodiment according to the present invention;

FIG. 2 is a circuit block diagram of the preferred embodiment according to the present invention;

FIG. 3 is a flow chart for signal processing according to the present invention; and

FIG. 4 is a flow chart for graphics registration according to the present invention.

### DETAILED DESCRIPTION OF THE PREFERRED EMBODIMENT

In the present invention a plurality of image sensors F are used to inspect printed graphics to be inspected. Each sensor picks up an image and digitizes the image so that one or more digital images are obtained for the related printed graphics. One of these image sensors is enough for inspection of ordinary color graphics without hologram. For printed graphics with hologram, different image sensors will get different images. A certain zone which can't be normally detected by one sensor may be normally detected by another sensor. Thus, the installation or angle adjustment of each sensor must be in a position to exclude such zone which is not able to be normally detected to assure that image of each zone of the printed graphics to be inspected can be picked up by a certain sensor.

The main principle applied in the present invention is the reflections are the dynamic images from hologram in different viewing angles are different—some providing intensive 3-D effect and reflection, while some providing weaker 3-D effect and reflection. For the images taken by the sensors F, inspecting some zones with relatively intensive reflection is impossible, while getting image for other zones for printed graphics inspection is possible. Therefore, using of a plurality of sensors can solve the problem of unable to take images due to diffraction.

Thus, for printed graphics to be inspected, an image of a corresponding printed graphics with good quality is taken by a plurality of image sensors F as a template for comparison purpose before the conveying device is started to send the printed graphics to a inspection location. A pair of light emitter and photo-electronic sensor are used to detect the printed graphics' displacement. When the printed graphics reaches a designated position, the related image sensors F is triggered to pick up image. The image picked is sent to a process 9 for registration and comparing with the template. Comparison with each template is implemented only at a designated zone. The results from all the comparisons are combined to identify the defects. Consequently, a final inspection result is obtained. Then, a controlling signal according to the result is given to a sorting device 11 for automatic sorting of the printed products, or another controlling signal can be given to the related printing machine 12 for on-line adjustment. Furthermore, the result of inspection, such as position and type of defects, can be sent through a communication control interface 10 to a server or a built-in register for storage and further analysis purpose.

The intelligent digital graphics inspection system according to the present invention comprises a conveying unit, an image signal picking-up unit, a graphics analysis and processing unit and a communication control interface unit. The conveying unit is mainly for conveying the printed graphics for inspection. The image signal picking-up unit is to pick up and digitalize the image. The graphics analysis and processing unit is for five main processes: processing the template images, registering it with the images picked, comparing the template images with the images picked, identifying the type of defects, outputting result of processing and controlling. The communication control interface 10 is to communicate with the related device including a sorting device 11 and a printing machine 12.

The image sensors F in the present invention can be an ordinary camera, a high-resolution image sensor such as CCD or CMOS sensor. There can be one or more sets of image sensors installed at different viewing angles. In case the output from the sensors F is analog, a digitizer is required to digitalize the output to be processed by the processor 9.

The light for the printed graphics according to the present invention can be a trichromatic light, flasher or other light source.

The processor 9 in the present invention can be a single processor, such as DSP, RISC, or CISC, or a plurality of processors (processor set), or a common computer.

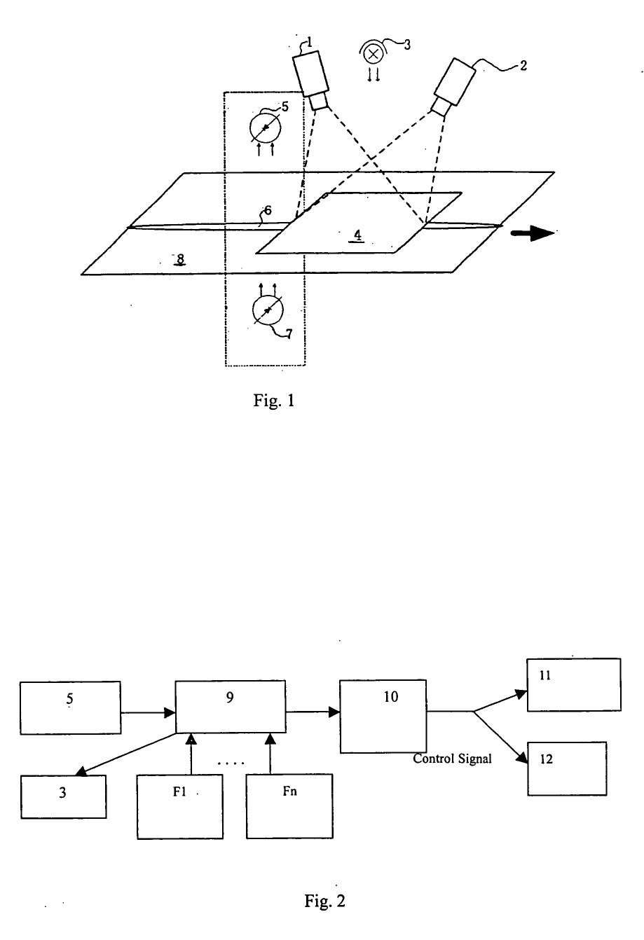

As shown in FIGS. 1 and 2, a preferred embodiment of the intelligent digital graphics inspection system comprises cameras F 1 and F2 as the image sensor set, lamp 3, printed graphics 4, photo-electronic sensor 5, slot 6, light emitter 7, conveyor 8 as the conveying device, processor 9, communication control interface 10, automatic sorting device 11 and printing device 12. The lamp 3 is used to illuminate. The photo-electronic sensor 5 and the light emitter 7 are used to detect the printed graphics 4. The slot 6 lies on the conveyor 8 through which the light emitted by the light emitter 7 can reach to the photo-electronic sensor 5. While a printed graphics 4 is brought by the conveyor 8 to a inspection position beneath the cameras F1 and F2, the printed graphics 4 is detected by a photo-electronic sensor 5 while it reaches the inspection position, the processor 9 receives a signal from the photo-electronic sensor 5 and triggers the cameras F1 and F2 to take an image of the printed graphics 4, and controls the cameras F1 and F2 for exposure after an analysis process. The processor 9 then registers the image from the cameras F1 and F2, comparing it with a corresponding template and identifying the type of defect. According to the result of processing, the processor 9 sends a control signal to control the automatic sorting device 11 or the printing device 12 for automatic printing quality adjustment and control.

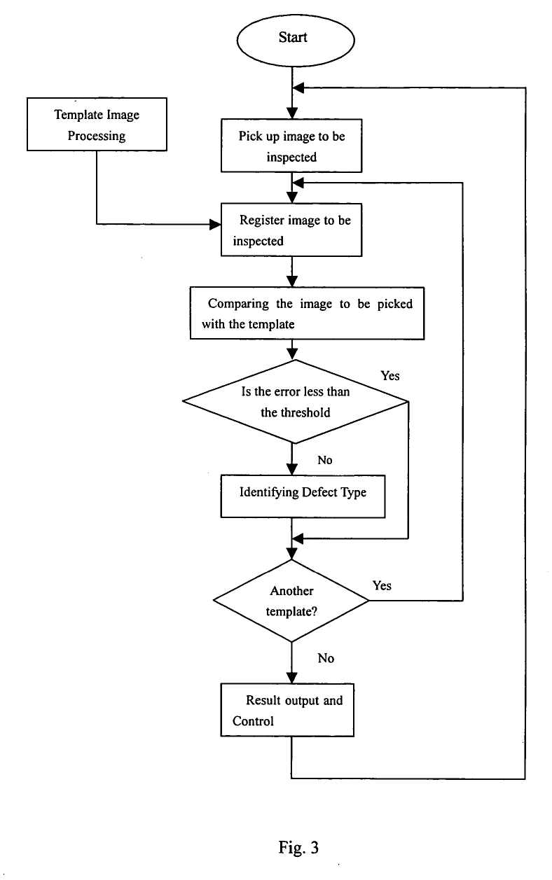

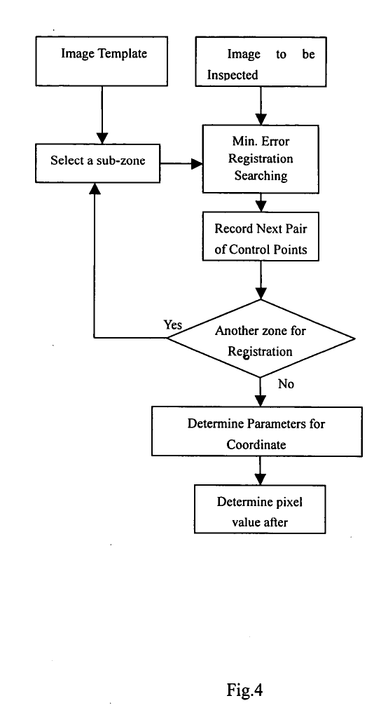

As shown in FIG. 3, after inputting of a set of digitalized graphic templates into the processor 9, the inspection zone of each template is determined by processing the graphic template. The corresponding inspection zone can be picked up by man-machine interaction method, and a number of sub-zones for geometric calibration are selected by man-machine interface method. For the digitalized image of the printed graphics 4 to be inspected, image registration is processed for registration with the templates obtained by the same cameras. The image for inspection after the registration process is then compared with its corresponding template by a differential inspection method to find out such zones with significant differences in red green and blue components, such as the zones greater than an absolute maximum difference, or a certain absolute difference, or beyond a threshold. The zones where such differences are inspected are then identified for the type of defects, such as pin hole, chromatic aberration, splash, black spot, color shift, dust, wrinkling, missing ink, scratch, ghosting, etc. Finally, the results of processing the images inspected and their corresponding templates are incorporated, and a control signal to control the automatic sorting device 11 or tune the printing device 12 is generated according to existence of defect, type and location of the defect.

Analysis and processing of the images picked up conclude the following steps:

(1) The templates are firstly processed to determine the inspection zone on each corresponding template. The inspection zone can be irregular, or composed of a plurality of regular sub-zones. To ease calculation, an inspection zone can be composed of a plurality of regular zones. To get a correct inspection zone and a combination of the inspection zones, each corresponding to a cameras, to cover the whole printed graphics 4 with some small overlapped area, the inspection zone can be determined by man-machine interaction method. For embedded type inspection device, this would require a communication control interface 10 to feed the images into the processor 9 and to send the information about the inspection zones determined through the man-machine interaction method to the inspection device.

(2) Image Registration: The image picked up by the image sensors F must be matched with its corresponding template for comparison. Geometric calibration method is applied for the matching between the image to be inspected and the template. As the image sensors F are installed at respective fixed locations, and the exposure to the printed graphics 4 is controlled through a photo-electronic inspection device, the position deviation of the printed graphics 4 to be inspected on the image is relatively small and there is only a relatively small displacement and rotating distortion, and there is no proportional distortion between the target image and the template. Then, distortion caused by deformation (unevenness) of the printed graphics 4 can be ignored. Since only rotating and displacement distortions are considered, calibration for geometric distortion requires only two control points and a linear equation. However, to increase precision, more controlling points can be used to calculate geometric calibration parameters (such as displacement and rotating degree parameter, or parameters for coordinate transformation equation).

Generally man-machine interaction method is used to determine the control points for geometric calibration. However, it is not precise enough for printing requiring a relatively high precision. In the present invention, automatic searching method is applied to determine the controlling point for sub-zone registration. Firstly, a plurality of sub-zones, such as 32×32 each, with apparent patterns on each template is selected manually for minimum error registration, such as by absolute error minimization or mean square error minimization. For each pair of sub-zones to be registered, a center coordinate (or a certain position) is applied as the control for geometric calibration for the two images. As the position deviation of the image on the printed graphics 4 is relative small, searching for minimum error registration can be implemented on a very small scope, such as within a corresponding position ±16 pixels along horizontal and vertical direction on the template.

(3) Comparing the template with the image inspected. Inspection for defects is done with differentiation on the red, green and blue spectrum, i.e., by absolute maximum error, sum-absolute-difference or other methods. Zone composed of pixels beyond a certain threshold value is defined as defected zone.

(4) Identification for type of defect: The defected zone inspected is ascertained for type of defect by mode identification method according to its shade, color shifting and other attributes.

(5) Outputting of the result of processing and controlling: A controlling signal is given according to the result of inspection to sort the printed graphics 4 inspected, and another controlling signal can be given to adjust the printing device 12 on line. The result of inspection, such as location and type of the defect, may be saved in a server through a communication port or a built-in register for analysis purpose in the future.

FIG. 4 illustrates an embodiment of the printing registration process according to the present invention. Each selected sub-zone is searched for registration with minimum error and then the coordinate for controlling point in determined. Through determining the coordinate of the controlling point, a coordinate transformation equation is determined, and finally a pixel value reflecting to the space of the template is determined to compare with the corresponding template.

The present invention has been described in detail with respect to preferred embodiments, and it will now be apparent from the foregoing to those skilled in the art that changes and modifications may be made without departing from the invention in its broader aspect, and it is the invention, therefore, in the apparent claims to cover all such changes to cover all such changes and modifications as fall within the true spirit of the invention.

What is claimed is:

1. An intelligent digital graphics inspection system comprising a conveying unit, an image signal picking-up unit, a graphics analysis and processing unit and a communication controlling interface unit; and characterized by using of photo-electronic inspection device to control the location of graphics to be inspected by a correlation method on the conveying unit, using of a set of image sensors to pick up image signals to get images of printed graphics to be inspected in different angles, using of image of templates for comparison purpose in the image signal picking-up unit, and using of a processor to analyze and process a plurality of images to identify defects in the graphics analysis and processing unit.

2. An inspection method for the intelligent digital graphics inspection system as claimed in claim 1 comprising (1) template image processing, (2) graphics registration, (3) comparing the image to be inspected with the template image, (4) identifying type of defects, and (5) outputting the result of processing and control signal; and characterized by installation of a plurality of sensors to pick up template images for processing and setting of a inspection zone for each sensor so that different zones are inspected by different sensors and a combination of all such inspection zones forms the whole zone requiring inspection in the template image processing; registration a plurality of images in the graphics registration; processing of a plurality of images in comparing the image to be inspected with the template image; and general analysis of the type of defect on each image in the identifying type of defects.

3. An inspection method for the intelligent digital graphics inspection system as claimed in claim 2 wherein a geometric calibration method based on a minimum error registration search is applied in the graphics registration: a plurality of sub-zones is first selected, then registration is done with regional search, and a coordinate designated on the sub-zone is applied as a controlling point for geometric calibration of the whole image in order to increase the precision of graphics registration.

4. An inspection method for the intelligent digital graphics inspection system as claimed in claim 2 wherein a mode identification method is applied to identify the type of defects, including shade, color shift and other attributes of the image being inspected.
